(19) United States
(12) Patent Application Publication
(10) Pub. No.: US 2011/0096315 A1
(43) Pub. Date: Apr. 28, 2011

(54) CALIBRATION METHOD AND LITHOGRAPHIC APPARATUS USING SUCH A CALIBRATION METHOD

(75) Inventor: Alejandro Xabier ARRIZABALAGA URIARTE, Veldhoven (NL)

(73) Assignee: ASML NETHERLANDS B.V., Veldhoven (NL)

(21) Appl. No.: 12/913,520

(22) Filed: Oct. 27, 2010

Related U.S. Application Data
(60) Provisional application No. 61/255,737, filed on Oct. 28, 2009.

(51) Int. Cl. G03B 27/54; G01B 11/14

(52) U.S. Cl. 355/67; 356/614

(57) ABSTRACT

A calibration method for calibrating a stage position includes projecting a pattern of a patterning device onto a substrate; measuring a resulting position of the projected pattern; and deriving a calibration of the stage position from the measured position, wherein, during the measuring, the substrate is rotated from a rotational starting position towards at least one other rotational position around a centre axis of the substrate, and a position of the projected pattern is measured for each of the at least two different rotational positions of the substrate, and wherein at least one of projection deviations in a position of the pattern occurring during the projecting and measurement deviations in a position of the pattern occurring during the measuring is determined by averaging the measured positions of the projected pattern for each of the different rotational positions of the substrate.

### CROSS REFERENCE TO RELATED APPLICATIONS

This application claims priority and benefit under 35 U.S.C. §119(e) to U.S. Provisional Patent Application No. 61/255,737, entitled “Calibration Method and Lithographic Apparatus Using Such A Calibration Method”, filed on Oct. 28, 2009. The content of that application is incorporated herein in its entirety by reference.

### FIELD

The present invention relates to a calibration method for a lithographic apparatus and a lithographic apparatus using such a calibration method.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It is known to use position measurement systems for measuring positions of the stages (such as a substrate stage or mask stage) in the lithographic apparatus. For example, it has been proposed to make use of an encoder measurement system. Thereto, an (e.g. two dimensional) encoder grid is applied which may be connected to a reference structure of the lithographic apparatus, while encoder sensor heads are connected to the stage so as to follow its position relative to the grid.

In order to calibrate the position measurement system, a plurality of calibrations is performed at present. In the case of the encoder measurement system, grid errors are for example calibrated by using data measured by the encoder system while moving the stage. Also a calibration wafer may be used.

Present calibration methods have a number of drawbacks. In particular they take up too much time. A quick fine-tuning of the system may not be possible. At the moment no fast fine-tuning calibration tests are available that are able to provide acceptable results. For example in the case of the encoder measurement system, a complete grid calibration may take several hours or even days. This leads to unacceptable long-downs of the lithographic apparatus each time the grid needs to be (re)calibrated and each time a grid verification test is needed to assess the validity of the grid calibration. Furthermore the present approach does not take into account clamping deformation of the wafer. As a result, some mid-frequency clamping errors, which are not calibrated, can survive, reducing the overlay performance of the apparatus. Finally, the calibration test using the calibration wafer depends too strongly on the quality of the calibration wafers used (i.e. it is a relative rather than an absolute calibration).

### SUMMARY

The present invention aims at overcoming the aforementioned disadvantages at least partly or to provide a usable alternative. In particular the invention aims at providing a user-friendly improved calibration method for calibrating the stage position of a lithographic apparatus which method is both fast and reliable.

According to an embodiment of the invention, there is provided a calibration method for calibrating a stage position of a stage of a lithographic apparatus, the method including: a projecting step in which a pattern of a patterning device is projected in a target position onto a substrate by a projection system; a measuring step in which the resulting position of the projected pattern on the substrate is measured by a position measurement system; and deriving a calibration of the stage position from the measured position of the projected pattern, wherein, during the measuring step, the substrate is rotated from a rotational starting position towards at least one other rotational position around a centre axis of the substrate, and the position of the projected pattern is measured for each of the at least two different rotational positions of the substrate, wherein the pattern is rotational symmetric around the centre axis of the substrate, and wherein at least one of projection deviations in the position of the pattern occurring during the projecting step and measurement deviations in the position of the pattern occurring during the measuring step is determined by averaging the measured positions of the projected pattern for each of the different rotational positions of the substrate.

According to an alternative embodiment there is provided a calibration method for calibrating a stage position of a stage of a lithographic apparatus, the method including: a projecting step in which a pattern of a patterning device is projected in a target position onto a substrate by a projection system; a measuring step in which the resulting position of the projected pattern on the substrate is measured by a position measurement system; and deriving a calibration of the stage position from the measured position of the projected pattern, wherein, during the projecting step, the substrate is rotated from a rotational starting position towards at least one other rotational position around a centre axis of the substrate, and the projection of the pattern takes place for each of the at least two different rotational positions of the substrate, wherein the patterns together are projected rotational symmetric around the centre axis of the substrate, wherein, during the measuring step, for each of the projected patterns the substrate is rotated towards the rotational starting position around the centre axis of the substrate, and the position of each of the projected patterns is measured in this same rotational starting position of the substrate, wherein at least one of projection deviations in the position of the patterns occurring during the projecting step and measurement deviations in the position of the patterns occurring during the measuring step is determined by averaging the measured positions of the projected patterns in the same rotational position of the substrate.

In another embodiment of the invention, there is provided a lithographic apparatus including: an illumination system configured to condition a radiation beam;

a support constructed to support a patterning device, the patterning device being capable of imparting the radiation beam with a pattern in its cross-section to form a patterned radiation beam; a substrate table constructed to hold a substrate; a projection system configured to project the patterned radiation beam onto a target portion of the substrate, and a control system to control an operation of the lithographic apparatus, wherein the control system is arranged to operate the lithographic apparatus so as to perform the calibration method according to an aspect of the invention.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIGS. 2a-c show a layout of rotational symmetric exposed patterns on a substrate;

FIGS. 3a-e show rotated readouts for averaging an estimate of a measure deviation;

FIGS. 4a-e show back-rotated readouts for averaging an estimate of an expose deviation;

FIGS. 5a-b show the expose impact of clamping deformation;

FIGS. 6a-b show the measure impact of clamping deformation; and

FIGS. 7a-b show differences between readouts at 0 and 90 degrees with respect to clamping deformations.

### DETAILED DESCRIPTION

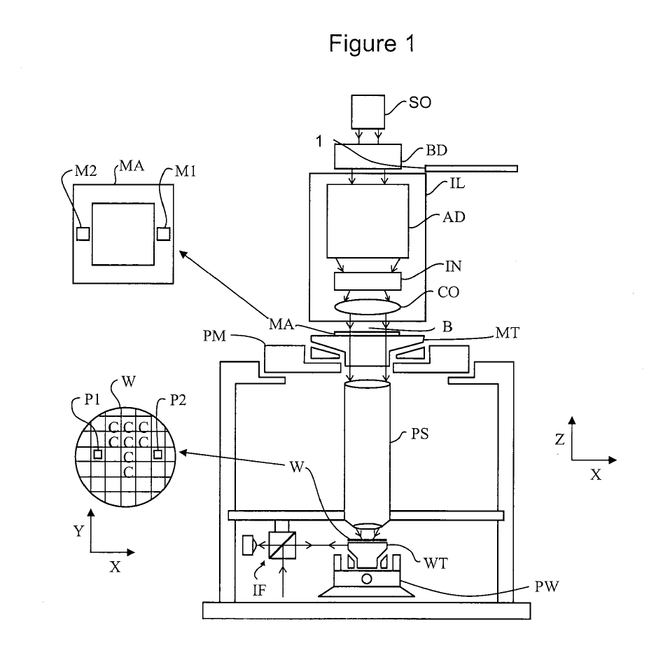

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator N and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.
2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT or “mask support” may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the patterning device support (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The lithographic apparatus, in particular one or more position measurement systems thereof, like for example the position sensor IF of the substrate table WT of FIG. 1 are calibrated before their first use, and are frequently recalibrated or verified during use. As an alternative position measurement system to the one shown in FIG. 1 it is also known to make use of a type including an (e.g. two dimensional) encoder measurement system. This encoder measurement system may include an encoder grid which is connected to a reference structure of the lithographic apparatus, while encoder sensor heads are connected to a moving stage of the apparatus, like to the moving substrate table WT thereof. Thus the encoder heads are able to follow the position of the substrate table WT relative to the encoder grid during projection of a pattern at a target position onto the substrate. As a consequence, inaccuracies, errors and other kinds of deviations in parts of the position measurement system, like in the encoder grid of the encoder measurement system, may translate into deviations, like overlay errors, of the pattern as created on the substrate W during the projection step. The pattern on the substrate W may subsequently be measured in a measurement step, in which the pattern is for example read out by an alignment sensor of the lithographic apparatus. The output signal of the alignment sensor then provides a signal corresponding to measured lines and/or dots of the pattern, and thus may provide information about any deviations in these lines and/or dots of the pattern. A first important cause of these deviations are the above mentioned deviations in the position measurement system during the projection step. A second important cause of these deviations are deviations in the position measurement system during the measurement step. Calibration of the position measurement system(s) for these deviations can be performed using the measurement results like the alignment sensor output signals.

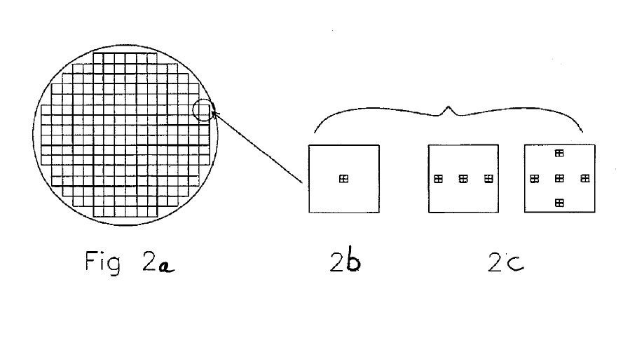

Below an embodiment of a calibration method according to the invention shall be described for calibrating a position measurement system of the encoder type for the calibration of the substrate table WT. This method starts with a projection procedure in which patterns are exposed onto the substrate W at various positions. Together the patterns form an image which, as can be seen in FIG. 2a, has a layout which is symmetric under rotations. The exposed patterns themselves are also symmetric under rotations and may for example include a single center pattern as shown in FIG. 2b, or a combination of such a center pattern together with a plurality of sub-patterns which are positioned equidistant around a centre axis of the pattern in the x- and/or y-directions as shown in FIG. 2c. Other rotational symmetric patterns and/or images are also possible. Since the projection procedure is performed by each time positioning the substrate W relative to an exposure encoder grid of the measurement system, deviations in this exposure encoder grid (denoted by E) are automatically copied together with the pattern onto the substrate W. Subsequently the calibration method includes the act of performing a measurement in which the projected pattern is read out. With this the position of the pattern on the substrate W is measured relative to a measure encoder grid. Deviations in this measure encoder grid (denoted by M) are thus automatically included in the measurement results.

It is noted that the exposure encoder grid and measure encoder grid in this example are two different grids since the substrate W is measured at another part of the lithographic apparatus than where the projection of the pattern onto the substrate W has taken place. For example, the projecting of the pattern on the substrate is performed at an exposure side of a dual stage lithographic apparatus, while the measuring is performed at a measurement side. It is also possible to perform the measuring procedure at an entirely different apparatus with its own measure encoder grid.

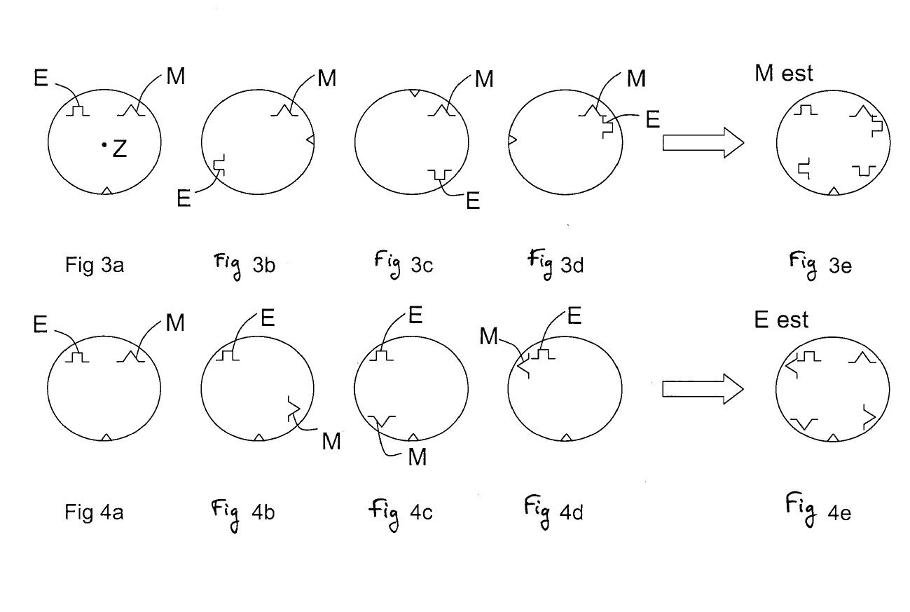

According to an embodiment of the invention, the position of the pattern on the substrate W is measured several times during the measuring procedure. First of all the position of the pattern on the substrate W is measured in a first rotational starting position (at 0°) of the substrate W, see FIG. 3a. Subsequently the substrate W is rotated over an angle of 90 degrees towards a second rotational position (at 90°) around its centre axis Z. The position of the pattern on the substrate W is also measured in this second rotational position, see FIG. 3b. Then the substrate W is rotated once again over an angle of 90 degrees towards a third rotational position (at 180°) in which the position of the pattern is measured once again, see FIG. 3c, after which the substrate W is rotated for the last time over an angle of 90 degrees towards a fourth rotational position (at 270°) in which the position of the pattern is measured for the fourth time, see FIG. 3d. Thus the position of the projected pattern is determined for each of the four different rotational positions of the substrate relative to the measure encoder grid. Every one of the four measurements of the rotational symmetric pattern on the substrate W results in a different combination of exposure and measure encoder grid deviations respectively. For instance, the readout at 0° would give information about E+M while the readout at 90° would give information about E₉₀+M, where E₉₀ denotes the exposure encoder grid deviation rotated towards the 90° rotational position, etc.

An embodiment of the invention is based on the insight that by adequately combining the data from the various rotated readouts the exposure and measure grid deviations can be separated from one another and thus can be suitably calibrated for. This is done in the following way:

An estimate Mest of the measure encoder grid deviation M can be obtained by taking the average of all four rotated readouts. This is possible since as can be seen in FIG. 3a-d all readouts keep containing the same measure grid deviation M. The fact that the substrate W is rotated over 90 degrees does not influence the direction and magnitude of the measure grid deviation. This is caused by the fact that the measure encoder grid and sensor heads of the position measurement system remain unchanged in their position relative to the substrate table WT. Only the substrate W is rotated relative to the substrate table WT. The exposure grid deviation E, on the contrary, is rotated together with a rotation of the substrate W. This is because any deviations in the projected pattern rotate together with the rotations of the substrate W, and these deviations in the pattern itself are assumed to be caused for the larger part during the projection procedure because of deviations E in the exposure encoder grid. Since the four rotational positions are symmetric around the center axis Z, the four measured rotated exposure grid deviations E substantially average each other out in the x- en y-directions. In this way they become noise on the total outcome when the four respective measurements are added together and divided by four (see FIG. 3e). In other words, deviations that rotate are considered to be exposure grid deviations E, whereas deviations that do not rotate are considered to be measured grid deviations M. By taking the average of the rotated pattern read-outs, the deviation M is kept unchanged while the deviation E is suppressed, producing a noise-like signal. Thus an estimate Mest for the measurement grid deviations M is obtained.

In a similar manner an estimate Eest of the exposure grid deviations E can be obtained by taking the average of all readouts after rotating the measured data such that the exposure grid deviations E share the same orientation (so-called back-rotated readouts). See FIG. 4a-e, wherein FIG. 4a shows a readout at 0°, FIG. 4b a readout at 90° rotated back to 0°, FIG. 4c a readout at 180° rotated back to 0°, FIG. 4d a readout at 270° rotated back to 0°, and FIG. 4e shows the exposure grid estimate. Taking the average of the substrate readouts rotated back to 0° keeps the exposure grid deviations E while the measure grid deviations M are combined to produce a noise-like signal. Thus an estimate Eest for the exposure grid deviations E is obtained.

The estimates for E and M can subsequently be used for deriving a proper calibration of the respective positions of the substrate table WT during projection and/or measurement.

The estimates Eest and Mest of E and M can be improved by first modeling out any substrate inter-field linear contributions, like translations, rotations and magnifications, from the measurement data. The reason for this is that one cannot distinguish whether any linear errors between the various substrate readouts are indeed (exposure or measure) encoder grid deviations or that they are due to substrate alignment errors. By first modeling out these inter-field linear contributions, the calibration according to an embodiment of the invention beneficially only looks at higher-order or non-linear encoder grid contributions.

The estimates of E and M can even be further improved by separating any rotational symmetric deviations in the measure and/or exposure encoder grids which may occur. The rotational symmetric deviations are seen in the estimates of E and M. A problem with this is that the averaging procedure cannot “tell” whether these rotational symmetric deviations come from E or M. These rotational symmetric errors are then most likely wrongly distributed between the estimates of E and M. In other words, the averaging procedure introduces an ambiguity in the determination of these rotational symmetric errors. It is noted that in the absence of rotational symmetric errors the estimates of E and M would be exact.

A further aspect of the invention proposes to reduce the impact of these rotational symmetric deviations on the accuracy of the determination of the encoder grids by redistributing their effect between the measure and exposure grids using an appropriate weighting procedure. The weighting procedure is a way to redistribute the rotational symmetric deviations among E and M. It works as follows: a) The total rotational symmetric deviations can be estimated by taking the average of four rotations of the previously obtained estimates of E and M (which shall be denoted with E′ and M′). This yields in R4(E+M), where R4 denotes the average of four rotations and E and M are here the exact exposure and measure grids. b) These total translational symmetric errors can be redistributed by assigning part of them to the estimate of E and the rest to the estimate of M. For instance, a natural way to redistribute them would be according to the magnitude of the deviations E and M themselves. So, the larger E is, the larger the part of the translational symmetric errors that is assigned to it. It is noted that the exact magnitude of E and M is not known since one only has estimates for them. However, the ratio E-to-M can be very well approximated by the ratio of [E′−R4(M′)]-to-[M′−R4(E′)]. Indeed, one can see that [E′−R4(M′)] depends only on the exact E whereas [M′−R4(E′)] depends only on the exact M.

In addition to or as an alternative for the weighting procedure described above, additional shifted sub-patterns as shown in FIG. 2b can be used to reduce the ambiguity introduced by the rotational symmetric deviations. The shifted sub-patterns have the same deviation E and thus the same rotational symmetric deviation in E as the center pattern. However, they have a different deviation M. This information can be used to separate the rotational symmetric deviations of E and M and thus reduce the ambiguity introduced by the rotational symmetric errors. The sub-patterns can be read out at one single or various rotations of the substrate W, as desired. Subsequently the measure and exposure grid contributions of the separated rotational symmetric deviations can then be distinguished and taken along during the calibration. An example of this weighting is that it has appeared that the size of the rotational symmetric deviations is usually proportional to the size of the complete encoder grid deviation. Other weightings are however also possible.

The additional shifted sub-patterns can also be used to provide a map of any Rz grid deviations made during projection, where Rz is the rotation error during the exposure. In this manner, also a calibration for any Rz exposure grid deviations can be performed. In order to be able to obtain optimal results with this the shift of the sub-patterns should preferably be larger than the typical grid deviation spatial frequency.

The accuracy of the calibration method according to an embodiment of the invention is ultimately determined by the presence and magnitude of the rotational symmetric contributions in the estimates. In the absence of these the calibration method is exact. However, typical encoder grid deviations E and M—even without rotational symmetric contributions—lead in practice to estimates that contain some rotational symmetric contributions. This is because the calibration method uses a finite number of rotations. Therefore the estimates obtained by averaging the rotated read-outs always have some non-zero rotational symmetric component due to the finite sampling. This leads to inaccuracies in the grid estimates E and M. These are
inversely proportional to the number of rotations. Therefore, the more rotations (rotated read-outs) are used, the more accurate the grid estimates.
directly proportional to the best absolute encoder grid (either measure or exposure). This makes the method suitable as a fine-tuning calibration technique. In a system with large grid overlay deviations the method can nonetheless also be used to accurately determine the encoder grid. To do so the exposed substrates should in addition be read out on another system with a well-calibrated measure encoder grid. The comparison of the readouts at the two systems provides accurate encoder grid estimates.

From simulations and actual test data it is observed that, for a single-pattern exposure readout under four rotations, the encoder grid estimates reproduce the absolute grids with an error of about 25% of the magnitude of the overlay deviations of the encoder grids themselves. This means that, for a system with 8 nm encoder grid, a calibration using this method would leave a residual grid of only 2 nm behind.

The method can be used as a relatively fast calibration/verification of the mid- to low-frequency encoder grid deviations. This makes the method quite useful as a fast fine-tuning correction of the encoder grid deformations/drifts that occur during the lifetime or during recoveries of the lithographic apparatus. In these situations the encoder grid changes are mostly mid- to low-frequency effects. The calibration method according to an embodiment of the invention can then save a lot of time compared to the complete state of the art encoder grid recalibration method. As an example, a complete one-substrate test with four rotated readouts would take approximately 30 minutes.

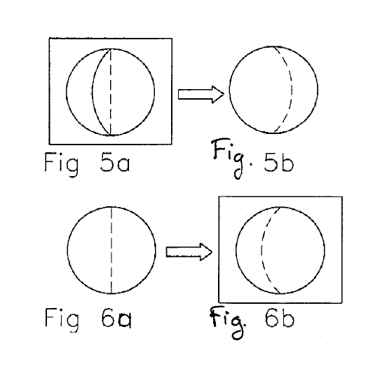

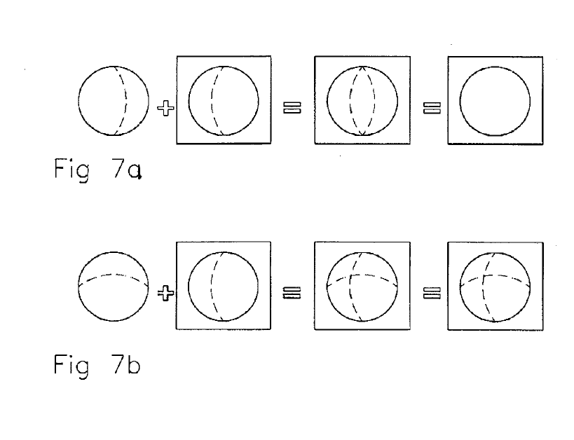

Another benefit of the calibration method according to an embodiment of the invention is that unlike the state of the art calibration method, it is sensitive to substrate clamping/deformation. In particular, the statistical contribution from substrate clamping/deformation on the exposure and measure grid deviations can be roughly estimated. This is done by comparing the readout at 0° for which the substrate clamping/deformation deviation does not appear, with the rotated readouts for which the wafer clamping/deformation deviation does appear. FIG. 5a shows a clamping deformation during a projection step, wherein the exposed image during exposure is indicated by E_{P} and the clamping grid error is indicated by C. This clamping deformation results in an inverse deviation in the projected pattern as shown in FIG. 5b. The same effect may occur during the measurement step as is shown in FIG. 6a, wherein the printed image in FIG. 6a is indicated by M_{P}, and the resulting effect in FIG. 6b. In FIG. 7a it can be seen that during a readout at 0° no clamping deformations deviations are seen, since the sum of the exposed wafer (left in addition) and measure wafer (right in addition) results in that no clamping/wafer deformation errors can be seen. FIG. 7b on the contrary shows that during a readout at other rotational positions (a readout at 90 degrees is shown in FIG. 7b), the effects of such clamping/wafer deformations can clearly be seen. This information can then be used to estimate the magnitude of the clamping deformation deviations.

Beneficially the calibration method according to an embodiment of the invention does not use reference substrates. Thus the method is insensitive to deviations in these reference substrates, and saves time in getting the reference substrates at the right place and at the right time.

Besides the embodiments shown numerous variants are possible. For example the calibration method may be applied to other stages and/or having other types of position measurement systems, such as interferometer, 1 dimensional encoder, 2 dimensional encoder, interferometer/encoder combinations, inductive, capacitive, etc. Besides for using the method for verification and calibration it is also possible for it to be used for the making of reference substrates. Using the results of the calibration method according to an embodiment of the invention it becomes possible to counteract any exposure encoder grid deviations by directly calibrating them. After this substrates exposed will have an almost ideal absolute grid and are thus suitable to be used as reference substrates. Since the errors induced at the measurement side of the apparatus can be removed from the data, it becomes known what is really projected on the substrates. This improves qualification of the substrates.

Instead of exposing a symmetric pattern and reading it out under N rotations, an equivalent calibration method would be to expose N patterns under N rotations symmetric around a centre axis of a substrate, and then reading each of these N patterns out at 0 degrees (the rotational starting position). Thus also at least one of projection deviations in the position of the patterns occurring during the projecting step and measurement deviations in the position of the patterns occurring during the measuring step can be efficiently determined by averaging the measured positions of the projected patterns in the same rotational position of the substrate.

The above calibrations may be implemented in a lithographic apparatus by e.g. a suitable programming of a controller which controls the operation of the lithographic apparatus. Instead of or in addition to programming by means of suitable programming instructions, any other way to make the controller arranged so as to have the calibration method performed, may be applied (e.g. dedicated hardware, etc). Instead of four rotations it is also possible to use another number of rotations, like for example three rotational positions during the measurement step, for example 0°, 60° and 120°. When only a calibration in one direction is needed then even two different rotational positions during the measurement step may suffice, in particular 0° and 180°. It is noted however that preferably at least three rotational positions are used in order to be able to provide sufficient accuracy. It is also possible to use more than four rotations during the measurement step.

Thus according to an embodiment of the present invention a calibration method is obtained which is fast and easy to implement in existing lithographic apparatus. It provides a faster alternative for mid- to low-frequency grid calibration/verification as compared to the current methods. The method is particularly suited for encoder grid fine-tuning and is very useful after a relatively long-down of a lithographic apparatus where often a complete recalibration of the position measurement system is unnecessary and too much time-consuming. Furthermore the method can distinguish and thus calibrate for encoder grid deviations due to substrate clamping/deformation.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A calibration method for calibrating a stage position of a stage of a lithographic apparatus, the method comprising:
projecting a pattern of a patterning device onto a target position of a substrate;
measuring a resulting position of the projected pattern on the substrate; and
deriving a calibration of the stage position from the measured position of the projected pattern,
wherein, during the measuring, the substrate is rotated from a rotational starting position towards at least one other rotational position around a centre axis of the substrate, and a position of the projected pattern is measured for each of the at least two different rotational positions of the substrate,
wherein the pattern is rotationally symmetric around the centre axis of the substrate, and
wherein projection deviations in a position of the pattern occurring during the projecting and/or measurement deviations in a position of the pattern occurring during the measuring is determined by averaging the measured positions of the projected pattern for each of the different rotational positions of the substrate.

2. The calibration method according to claim 1, wherein, during the measuring, the substrate is rotated from a rotational starting position towards at least two other rotational positions around a centre axis of the substrate, and the position of the projected pattern is measured for each of the at least three different rotational positions of the substrate.

3. The calibration method according to claim 2, wherein, during the measuring, the substrate is rotated from a rotational starting position towards at least three other rotational positions around a centre axis of the substrate, and the position of the projected pattern is measured for each of the at least four different rotational positions of the substrate, the at least four rotational positions including angles of 0, 90, 180 and 270 degrees.

4. The calibration method according to claim 1, wherein both the projection deviations and the measurement deviations are determined by averaging the measured positions of the projected pattern for each of the different rotational positions of the substrate.

5. The calibration method according to claim 1, wherein the pattern comprises a rotational symmetric center pattern which is centered in the centre axis of the substrate.

6. The calibration method according to claim 1, wherein the pattern comprises a rotational symmetric assembly of sub-patterns which are divided equidistant around a circumference of the centre axis of the pattern.

7. The calibration method according to claim 1, wherein, during the projecting, a position measurement system is configured to determine the target position at which the pattern is to be projected onto the substrate, wherein the projection deviations are linked to deviations in the position measurement system.

8. The calibration method according to claim 7, wherein the position measurement system comprises an exposure grid, wherein the projection deviations are linked to deviations in the exposure grid.

9. The calibration method according to claim 1, wherein, during the measuring, a position measurement system is configured to determine the resulting position at which the pattern has been projected onto the substrate, wherein the measurement deviations are linked to deviations in the position measurement system.

10. The calibration method according to claim 9, wherein the position measurement system comprises a measure grid, wherein the measurement deviations are linked to deviations in the measure grid.

11. A calibration method for calibrating a stage position of a stage of a lithographic apparatus, the method comprising:
projecting patterns of a patterning device onto target positions on a substrate;
measuring resulting positions of the projected pattern on the substrate; and
deriving a calibration of the stage position from the measured positions of the projected pattern,
wherein, during the projecting, the substrate is rotated from a rotational starting position towards at least one other rotational position around a centre axis of the substrate, and the projection of pattern takes place for each of the at least two different rotational positions of the substrate,
wherein the patterns together are projected rotationally symmetric around the centre axis of the substrate,
wherein, during the measuring, for each of the projected patterns the substrate is rotated towards the rotational starting position around the centre axis of the substrate, and the position of each of the projected patterns is measured in the same rotational starting position of the substrate,
wherein projection deviations in the position of the patterns occurring during the projecting and/or measurement deviations in the position of the patterns occurring during the measuring is determined by averaging the measured positions of the projected patterns in the same rotational position of the substrate.

12. A lithographic apparatus comprising:
a support constructed to support a patterning device, the patterning device being capable of imparting a radiation beam with a pattern in its cross-section to form a patterned radiation beam;
a substrate table constructed to hold a substrate;
a projection system configured to project the patterned radiation beam onto a target portion of the substrate; and
a controller arranged to perform a calibration method according to claim 1.

13. A lithographic apparatus comprising:
a support constructed to support a patterning device, the patterning device being capable of imparting a radiation beam with a pattern in its cross-section to form a patterned radiation beam;
a substrate table constructed to hold a substrate;
a projection system configured to project the patterned radiation beam onto a target portion of the substrate; and
a controller arranged to perform a calibration method according to claim 11.
